(19) United States
(12) Patent Application Publication
(10) Pub. No.: US 2025/0334165 A1
(43) Pub. Date: Oct. 30, 2025

(54) SUSPENSION ASSEMBLY

(71) Applicant: HAYES BICYCLE GROUP INC., Mequon, WI (US)

(72) Inventor: Edward C KWATERSKI, Cedarburg, WI (US)

(73) Assignee: HAYES BICYCLE GROUP INC, MEQUON, WI (US)

(21) Appl. No.: 19/189,580

(22) Filed: Apr. 25, 2025

Related U.S. Application Data
(60) Provisional application No. 63/640,866, filed on Apr. 30, 2024.

(51) Int. Cl. F16F 9/348; B62K 25/08; B62K 25/28; B62K 25/30; F16F 9/19; F16F 9/36; F16F 9/46

(52) U.S. Cl. CPC F16F 9/3488; B62K 25/08; B62K 25/286; B62K 25/30; F16F 9/19; F16F 9/368; F16F 9/464; F16F 2222/12; F16F 2228/066; F16F 2228/08; F16F 2230/186; F16F 2230/30; F16F 2232/08; F16F 2234/02

(57) ABSTRACT

A suspension system comprising a damper assembly is disclosed. The system comprises a shaft and a piston and a shim on the shaft and a collar to apply a preload to the shim and a seal in sealing engagement such that the damping fluid cannot flow between the shim and outer surface of the shaft. The damper assembly may be provided for a suspension fork or shock absorber. The collar and shim are movable along the shaft. The seal may comprise an elastomeric element. Position of the collar along the shaft changes preload of the shim. The shim may be configured to obstruct an internal passage of the piston when the damping fluid pressure is below a threshold and to deflect to open the internal passage of the piston when the damping fluid pressure is above the threshold. A n adjuster may provide adjustment of position of the collar along the shaft.

### CROSS-REFERENCE TO RELATED APPLICATIONS

The present application claims priority to and incorporates by reference in full U.S. Provisional Patent Application No. 63/640,866 titled “SUSPENSION ASSEMBLY” filed on Apr. 30, 2024.

### FIELD

The present invention relates to a suspension assembly for a bicycle.

### BACKGROUND

It is known to provide a suspension assembly for a bicycle.

It would be advantageous to provide an improved suspension assembly comprising a seal at a flow control element.

It would be advantageous to provide an improved suspension assembly comprising an improved arrangement for a seal at a flow control element comprising a shim stack/shim.

It would be advantageous to provide an improved suspension assembly comprising an improved arrangement for a seal at a flow control element comprising a shim stack/shim for a damper assembly for a suspension system for a bicycle.

It would be advantageous to provide an improved suspension assembly comprising an improved arrangement for a seal at a flow control element comprising a shim stack/shim for a damper assembly for a suspension system comprising a rear shock absorber.

It would be advantageous to provide an improved suspension assembly comprising an improved arrangement for a seal at a flow control element comprising a shim stack/shim for a damper assembly for a suspension system comprising a suspension fork.

It would be advantageous to provide an improved suspension assembly comprising an improved arrangement for a seal ring at a flow control element comprising a shim stack/shim for a damper assembly for a suspension system for a bicycle.

### SUMMARY

The present invention relates to a suspension system comprising a damper assembly comprising a shaft and a piston comprising an internal passage for damping fluid and a shim adjacent to the piston configured to fit onto the shaft and a collar configured to apply a preload to the shim and a seal provided on the shaft at the shim; the seal may comprise a seal ring in sealing engagement with the shim and the shaft such that the damping fluid cannot flow between the shim and an outer surface of the shaft. The system may comprise a suspension fork; the damper assembly may be configured to be contained within the suspension fork. The system may comprise a shock absorber; the damper assembly may be configured to be contained within the shock absorber. The collar is movable along the outer surface of the shaft; the shim is movable along the outer surface of the shaft. The shim is configured to close off the internal passage of the piston; a radially-outer portion of the shim contacts the piston; a radially-inner portion of the shim contacts the collar. The seal may comprise an elastomeric element; the seal may comprise an O-ring; the collar may comprise a gland for the seal. The position of the collar along the shaft changes the preload of the shim. The preload on the shim is adjustable by an adjuster. The position of the collar along the shaft is user adjustable by the adjuster. The shim may be configured to obstruct the internal passage of the piston when the damping fluid pressure is below a threshold pressure and to deflect to open the internal passage of the piston when the damping fluid pressure is above the threshold pressure. The shim may comprise a flow control element; the operator control may be configured to provide adjustment of position of the collar along the shaft for the flow control element.

The present invention relates to a damper assembly for a suspension system comprising a shaft having an outer surface and a piston comprising an internal passage for damping fluid and a flow control element adjacent to the piston and configured to fit on the shaft and a seal provided on the shaft adjacent to the flow control element and the seal is configured to prevent flow of damping fluid along the shaft at the flow control element. The seal may comprise an elastomeric ring fit onto the shaft; The flow control element may comprise a valve; the seal is configured to engage the valve and the shaft to prevent flow of damping fluid between the valve and the outer surface of the shaft. The flow control element may comprise a shim; the seal is configured to engage the shim and the shaft to prevent flow of damping fluid between the shim and the outer surface of the shaft. The assembly may comprise a collar configured to apply a preload to the shim; the assembly may comprise an operator control for adjustment of the damper assembly; the operator control is configured to provide adjustment of position of the collar along the shaft.

The present invention relates to a suspension assembly comprising a damper assembly comprising a shaft and a piston and a shim and a collar and a seal and an operator control; the piston may comprise an internal passage for damping fluid; the shim is fit on the shaft and adjacent to the piston; the shim has a preload applied by the collar; the operator control may be configured to provide adjustment of the preload by movement of the collar along the shaft; the seal may be in sealing engagement with the shim and the shaft such that damping fluid cannot flow between the shim and the shaft.

The present invention relates to a suspension system comprising a damper assembly comprising a shaft and a piston comprising an internal passage for damping fluid and a shim adjacent to the piston configured to fit onto the shaft and a collar configured to apply a preload to the shim and a seal provided on the shaft at the shim; the seal may comprise a seal ring in a sealing engagement with the shim and the shaft such that the damping fluid cannot flow between the inner hole of the shim and an outer surface of the shaft. The suspension system may comprise a suspension fork; the damper assembly may be configured to be contained within the suspension fork. The suspension system may comprise a shock absorber; the damper assembly may be configured to be contained within the shock absorber. The shim may comprise an inner hole; the collar may be movable along the outer surface of the shaft; the shim may be movable along the shaft; the shim closes off the internal passage of the piston when the damping fluid pressure is be below a threshold pressure and the shim deflects to open the internal passage of the piston when the damping fluid pressure is above the threshold pressure. The collar may comprise a gland for the seal ring; the seal ring may comprise an elastomeric element; the seal ring may comprise an O-ring. The preload on the shim may be adjustable. A radially-outer portion of the shim contacts the piston; a radially-inner portion of the shim contacts the collar; position of the collar along the shaft changes the preload of the shim; position of the collar along the shaft may be user adjustable. The system may comprise an operator control for adjustment of the damper assembly; the operator control may be configured to provide adjustment of position of the collar along the shaft. The shim may comprise a flow control element; the operator control may be configured to provide adjustment of position of the collar along the shaft for the flow control element. The damper assembly may comprise a damper; the damper may comprise the piston and the shim and the shaft and the collar and the seal; the inner hole of the shim may comprise a circular hole; the outer surface of the shaft may comprise a cylindrical surface; the collar may be movable along the shaft; the shim may be movable along the shaft. The shim closes off the internal passage of the piston when the damping fluid pressure is below a threshold pressure and the shim deflects to open the internal passage of the piston when the damping fluid pressure is above the threshold pressure; position of the collar along the shaft changes the preload of the shim; the position of the collar along the shaft may be user adjustable. The suspension system may comprise a suspension fork; the damper assembly may be configured to be contained within the suspension fork. The suspension system may comprise a shock absorber; the damper assembly may be configured to be contained within the shock absorber.

The present invention relates to a damper assembly for a suspension system with a chamber for damping fluid comprising a shaft having an outer surface and a piston comprising an internal passage for damping fluid and a flow control element adjacent to the piston and with an inner hole configured to fit onto the shaft and a seal provided on the shaft adjacent to the flow control element; the seal may be configured to prevent flow of damping fluid along the shaft at the flow control element; the seal may be provided on the shaft at the flow control element, the seal may be configured to prevent flow of damping fluid along the shaft at the flow control element; the seal may comprise an elastomeric element fit onto the shaft. The flow control element may comprise a shim comprising an inner hole. The assembly may comprise a collar configured to apply a preload to the shim. The seal may be configured to engage with the shim and the shaft to prevent flow of damping fluid between the inner hole of the shim and the outer surface of the shaft.

The present invention relates to a suspension assembly comprising a damper assembly comprising a piston and a shim and a shaft and a collar and a seal and damping fluid; the piston may comprise an internal passage for the damping fluid; the shim may be adjacent to the piston; the shim has a preload applied by the collar; the shim may comprise an inner hole; the shaft may comprise an outer cylindrical surface; the outer cylindrical surface of the shaft may be within the shim inner hole; the seal is in a sealing engagement with the shim and the shaft such that the damping fluid cannot flow between the shim inner hole and the shaft outer cylindrical surface. The system may comprise an adjuster for adjustment of the damper assembly; the adjuster may be configured to provide adjustment of position of the collar along the shaft. The collar may be movable along the shaft; the shim may be movable along the shaft. The shim may comprise a valve; the adjuster may be configured to provide adjustment of position of the collar along the shaft for the valve. The valve closes off the internal passage of the piston when the damping fluid pressure is below a threshold pressure and the shim deflects to open the internal passage of the piston when the damping fluid pressure is above the threshold pressure. The seal may be an elastomeric O-ring. A radially-outer portion of the shim contacts the piston; a radially-inner portion of the shim contacts the collar. The position of the collar along the shaft changes the preload of the shim; the position of the collar along the shaft may be user adjustable. The present invention relates to a suspension system comprising a damper assembly; the damper assembly may comprise a shaft and a piston comprising an internal passage for damping fluid and a flow control element/valve comprising a shim/shim stack adjacent to the piston configured to fit onto the shaft and a collar configured to apply a preload to the shim and a seal provided on the shaft at the shim; the seal may comprise a seal ring in a sealing engagement with the shim and the shaft such that the damping fluid cannot flow between the inner hole of the shim and the outer surface of the shaft. The damper assembly may be configured for a suspension assembly for a bicycle. The suspension assembly may comprise a suspension fork; the damper assembly may be configured to be contained within the suspension fork; the suspension fork may be attached to a bicycle. The suspension assembly may comprise a shock absorber; the damper assembly may be configured to be contained within the shock absorber. The system may be configured to be contained within the shock absorber; the shock absorber may be attached to a bicycle. The damper assembly may comprise a damper; the damper may comprise the piston and the shim and the shaft and the collar and the seal ring. The shim may comprise a flow control element; the shim may comprise a valve. The shim may comprise an inner hole; wherein the inner hole may comprise a circular hole. The shaft may comprise an outer surface; wherein the outer surface of the shaft may comprise a cylindrical surface. The collar may be movable along the shaft. The shim may be movable along the shaft. The shim may be configured to close off the internal passage of the piston when the damping fluid pressure may be below a threshold pressure and the shim deflects to open the internal passage of the piston when the damping fluid pressure may be above the threshold pressure. The collar may comprise a gland for the seal. The seal ring may comprise an O-ring; the seal may comprise an X-ring. The preload on the shim may be adjustable. The radially-outer portion of the shim may be configured to contact the piston. The radially-inner portion of the shim may be configured to contact the collar. Position of the collar along the shaft may be configured to change the preload of the shim; position of the collar along the shaft may be user adjustable. The system may comprise an operator control for adjustment of the damper assembly; the operator control may comprise an adjuster for the damper assembly; the adjuster for the damper assembly may comprise a knob; the adjuster for the damper assembly may comprise a dial. The adjuster may be configured to provide adjustment of position of the collar along the shaft. The suspension system may comprise a suspension assembly.

The present invention relates to a damper assembly for a suspension system comprising a suspension assembly. The damper assembly may comprise a shaft having an outer surface and a piston comprising an internal passage for damping fluid and a shim adjacent to the piston and with an inner hole configured to fit onto the shaft and a collar configured to apply a preload to the shim and a seal provided on the shaft adjacent to the shim; the system may comprise the seal in a sealing engagement with the shim and the shaft such that the damping fluid cannot flow between the inner hole of the shim and the outer surface of the shaft.

The present invention relates to a damper assembly; the damper assembly may comprise a shaft having an outer surface and a piston comprising an internal passage for damping fluid and a shim adjacent to the piston and with an inner hole configured to fit onto the shaft and a collar configured to apply a preload to the shim and a seal provided on the shaft at the shim; the system may comprise the seal in a sealing engagement with the shim and the shaft such that the damping fluid cannot flow between the inner hole of the shim and the outer surface of the shaft. The damper assembly may comprise a damper. The damper may comprise the piston and the shim and the shaft and the collar and the seal. The inner hole of the shim may comprise a circular hole. The outer surface of the shaft may comprise a cylindrical surface. The collar may be movable along the shaft. The shim may be movable along the shaft. The shim may be configured to close off the internal passage of the piston when the damping fluid pressure may be below a threshold pressure and the shim may be configured to deflect to open the internal passage of the piston when the damping fluid pressure may be above the threshold pressure. The collar may comprise a gland for the seal. The seal may be an O-ring. The seal may be an X-ring. The preload on the shim may be adjustable. The radially-outer portion of the shim contacts the piston. The radially-inner portion of the shim contacts the collar. The position of the collar along the shaft changes the preload of the shim. The position of the collar along the shaft may be user-adjustable. The adjuster for adjustment of the position of the collar along the shaft may be a knob. The system may be configured for a suspension assembly for a bicycle; the suspension assembly may comprise a suspension fork. The damper assembly may be configured to be contained within the suspension fork; the suspension fork may be attached to a bicycle. The suspension assembly may comprise a shock absorber. The system may be configured to be contained within the shock absorber. The shock absorber may be attached to a bicycle.

The present invention relates to a damper assembly for a suspension system with a chamber for damping fluid; the damper assembly may comprise a shaft having an outer surface and a piston comprising an internal passage for damping fluid and a flow control element adjacent to the piston and with an inner hole configured to fit onto the shaft and a seal provided on the shaft adjacent to the flow control element; the seal may be configured to prevent flow of damping fluid along the shaft at the flow control element.

The present invention relates to a damper assembly for a suspension system with a chamber for damping fluid; the damper assembly may comprise a shaft having an outer surface and a piston comprising an internal passage for damping fluid and a flow control element adjacent to the piston and with an inner hole configured to fit onto the shaft and a seal provided on the shaft at the flow control element; the seal may be configured to prevent flow of damping fluid along the shaft at the flow control element. The seal may comprise a ring. The seal may comprise an O-ring. The seal may comprise an elastomeric element. The seal may comprise an elastomeric element fit onto the shaft. The flow control element may comprise a shim. The shim may comprise an inner hole. The shim may comprise a circular hole. The outer surface of the shaft may comprise a cylindrical surface. The assembly may comprise a collar configured to apply a preload to the shim. The seal may be configured to engage with the shim and the shaft to prevent flow of damping fluid between the inner hole of the shim and the outer surface of the shaft.

The present invention relates to a damper assembly for a suspension system with a chamber for damping fluid; the damper assembly may comprise a shaft having an outer surface and a piston comprising an internal passage for damping fluid and a shim adjacent to the piston and with an inner hole configured to fit onto the shaft and a collar configured to apply a preload to the shim and a seal provided on the shaft adjacent to the shim; the seal may be configured to engage with the shim and the shaft to prevent flow of damping fluid between the inner hole of the shim and the outer surface of the shaft.

The present invention relates to a damper assembly for a suspension system with a chamber for damping fluid; the damper assembly may comprise a shaft having an outer surface and a piston comprising an internal passage for damping fluid and a shim adjacent to the piston and with an inner hole configured to fit onto the shaft and a collar configured to apply a preload to the shim and a seal provided on the shaft at the shim; the seal may be configured to engage with the shim and the shaft to prevent flow of damping fluid between the inner hole of the shim and the outer surface of the shaft. The inner hole of the shim may comprise a circular hole. The outer surface of the shaft may comprise a cylindrical surface.

The present invention relates to a damper assembly; the damper assembly may comprise a piston and a shim and a shaft and a collar and a seal and damping fluid; the piston may comprise an internal passage for the damping fluid; the shim may be adjacent to the piston; the shim has a preload applied by the collar; the shim may comprise an inner hole; the shaft may comprise an outer cylindrical surface; the outer cylindrical surface of the shaft may be within the shim inner hole; the system may comprise the seal in a sealing engagement with the shim and the shaft such that the damping fluid cannot flow between the shim inner hole and the shaft outer cylindrical surface. The assembly may comprise a damper. The damper may comprise the piston and the shim and the shaft and the collar and the seal. The collar may be movable along the shaft. The shim may be movable along the shaft. The shim closes off the internal passage of the piston when the damping fluid pressure may be below a threshold pressure and the shim may be configured to deflect to open the internal passage of the piston when the damping fluid pressure may be above the threshold pressure. The collar may comprise a gland for the seal. The seal may be an O-ring. The seal may be an X-ring. The preload on the shim may be adjustable. The radially-outer portion of the shim contacts the piston. The radially-inner portion of the shim contacts the collar. The position of the collar along the shaft changes the preload of the shim. The position of the collar along the shaft may be user-adjustable. The adjuster for adjustment of the position of the collar along the shaft may be a knob. The suspension system may be configured for a suspension assembly for a bicycle. The suspension assembly may comprise a suspension fork. The suspension system may be configured to be contained within the suspension fork. The suspension fork may be attached to a bicycle. The suspension assembly may comprise a shock absorber. The suspension system may be configured to be contained within the shock absorber. The shock absorber may be attached to a bicycle.

### FIGURES

FIG. 1 is schematic perspective view of a bicycle according to an exemplary embodiment.

FIG. 2 is schematic front elevation view of a suspension assembly shown as a shock absorber for a bicycle according to an exemplary embodiment.

FIG. 3 is schematic front elevation view of a suspension assembly shown as a suspension fork for a bicycle according to an exemplary embodiment.

FIG. 4 is schematic exploded front elevation view of a suspension assembly for a bicycle according to an exemplary embodiment.

FIG. 5 is schematic exploded front elevation view of a damper assembly for a suspension assembly for a bicycle according to an exemplary embodiment.

FIG. 6A is schematic front elevation cross-section view of a suspension assembly for a bicycle according to an exemplary embodiment.

FIG. 6B is schematic front elevation cross-section view of a suspension assembly for a bicycle according to an exemplary embodiment.

FIG. 7 is a schematic perspective of collar for a damper assembly for a suspension assembly for a bicycle according to an exemplary embodiment.

FIG. 8A is schematic partial front elevation cross-section view of a suspension assembly for a bicycle according to an exemplary embodiment.

FIG. 8B is schematic partial front elevation cross-section view of a suspension assembly for a bicycle according to an exemplary embodiment.

FIG. 9A is schematic perspective of seal/ring for a damper assembly for a suspension assembly for a bicycle according to an exemplary embodiment.

FIG. 9B is schematic partial front elevation cross-section view of a damper assembly for a suspension assembly for a bicycle according to an exemplary embodiment.

FIG. 10A is schematic perspective of seal/ring for a damper assembly for a suspension assembly for a bicycle according to an exemplary embodiment.

FIG. 10B is schematic partial front elevation cross-section view of a damper assembly for a suspension assembly for a bicycle according to an exemplary embodiment.

FIG. 11A is schematic perspective of seal/ring for a damper assembly for a suspension assembly for a bicycle according to an exemplary embodiment.

FIG. 11B is schematic partial front elevation cross-section view of a damper assembly for a suspension assembly for a bicycle according to an exemplary embodiment.

FIG. 12A is schematic front elevation cross-section view of a suspension assembly for a bicycle according to an exemplary embodiment.

FIG. 12B is schematic partial front elevation cross-section view of a damper assembly for a suspension assembly according to an exemplary embodiment.

FIG. 13A is schematic representative front elevation cross-section view of a suspension assembly for a bicycle.

FIG. 13B is schematic partial front elevation cross-section view of a damper assembly for a suspension assembly for a bicycle of FIG. 13A.

### DESCRIPTION

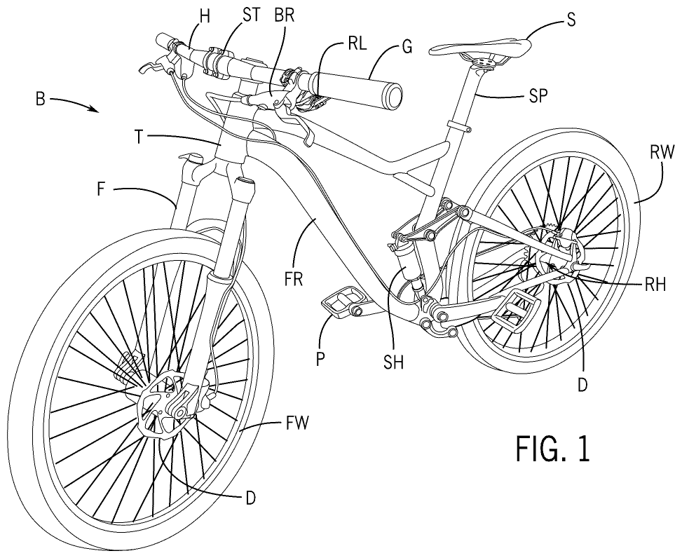

Referring to FIG. 1, a bicycle B is shown schematically according to an exemplary embodiment providing an arrangement of parts/components including a frame FR with a head tube T and a seat post SP (with seat S) and a set of wheels comprising front wheel FW with a front fork/suspension assembly F and rear wheel RW with a rear shock absorber/suspension assembly SH coupled to the frame FR and a set of pedals P; the bicycle provides handlebar H (coupled to front wheel FW through stem ST and front fork assembly F and through head tube T) with grip G and with operator control R L (shown with remote lever) and with operator control for a brake system B R coupled to a brake disc D (e.g. rotor at/on each of front wheel FW and rear wheel RW) and a gear/shift control (coupled to a selectable gear system for rear wheel RW).

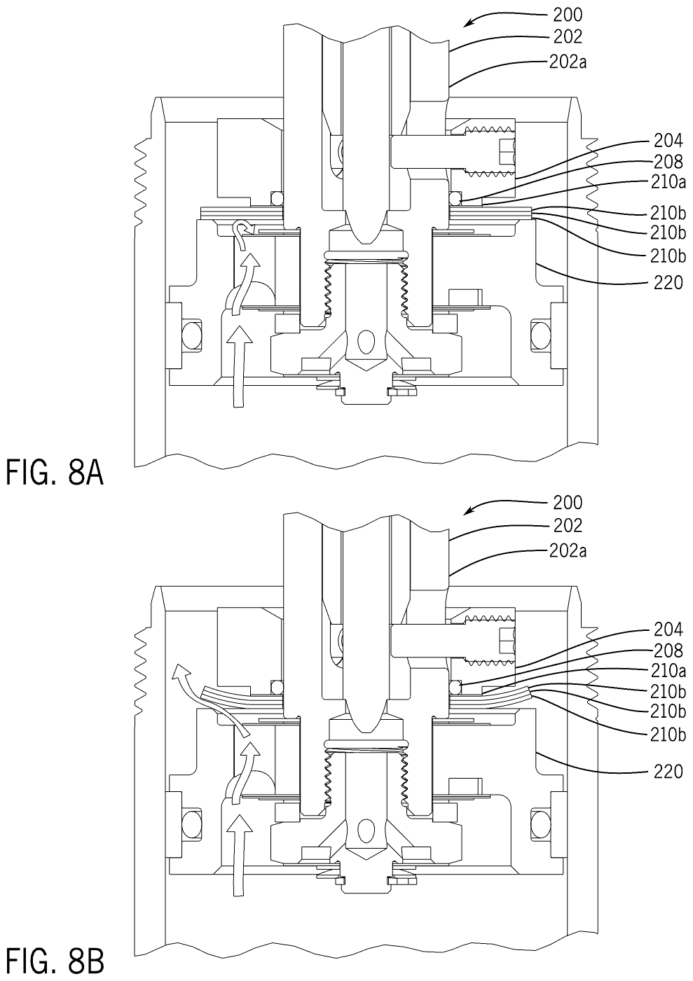

According to an exemplary embodiment as shown schematically in FIGS. 1, 2, 4, 5 and 6A-6B, the suspension system may comprise a rear shock absorber/suspension assembly SH/100 configured to be attached to the frame of the bicycle at mounting bushings 108a/108b; suspension assembly SH/100 may be configured to provide a damper assembly 200; suspension assembly SH/100 with damper assembly 200 may comprise a top cap assembly 110 for tube/assembly shown as air can assembly 140 and a damper tube/assembly 130; the suspension system with damper assembly may comprise an operator control shown as an adjuster providing a knob 180; damper assembly 200 may comprise a piston assembly 220x. See also FIGS. 8A-8B, 9A-9B, 10A-10B and 11A-11B.

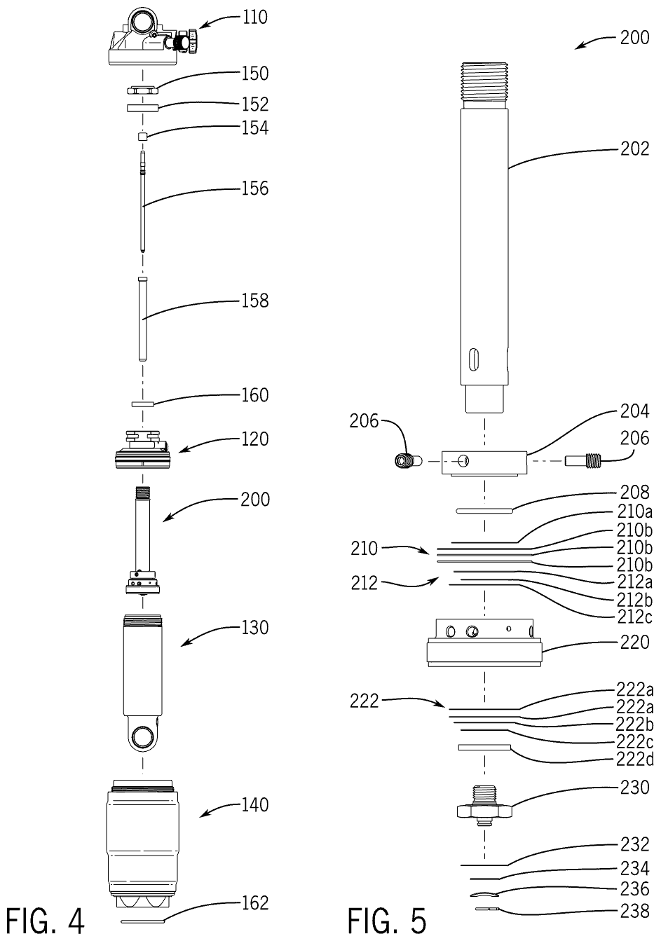

According to an exemplary embodiment as shown schematically in FIGS. 1, 3 and 12A-12B, the suspension system may comprise a front fork suspension/suspension assembly F/100x configured to be attached to the front wheel of the bicycle at axle 108x; suspension assembly F/100x may be configured to provide a damper assembly 200x; suspension assembly F/100x with damper assembly 200x may comprise tube/assembly 130x and tube/assembly 140x; the suspension system with damper assembly may comprise an operator control shown as an adjuster providing a dial 180x; damper assembly may comprise damper assembly 200x may comprise a piston assembly 220x. See also FIGS. 4, 5, 8A-8B, 9A-9B, 10A-10B and 11A-11B.

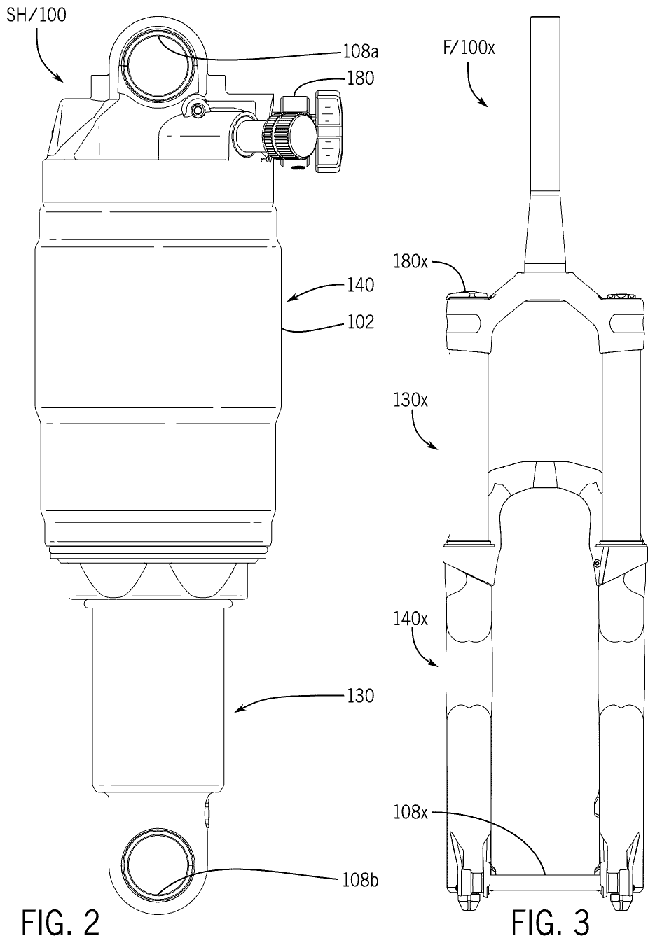

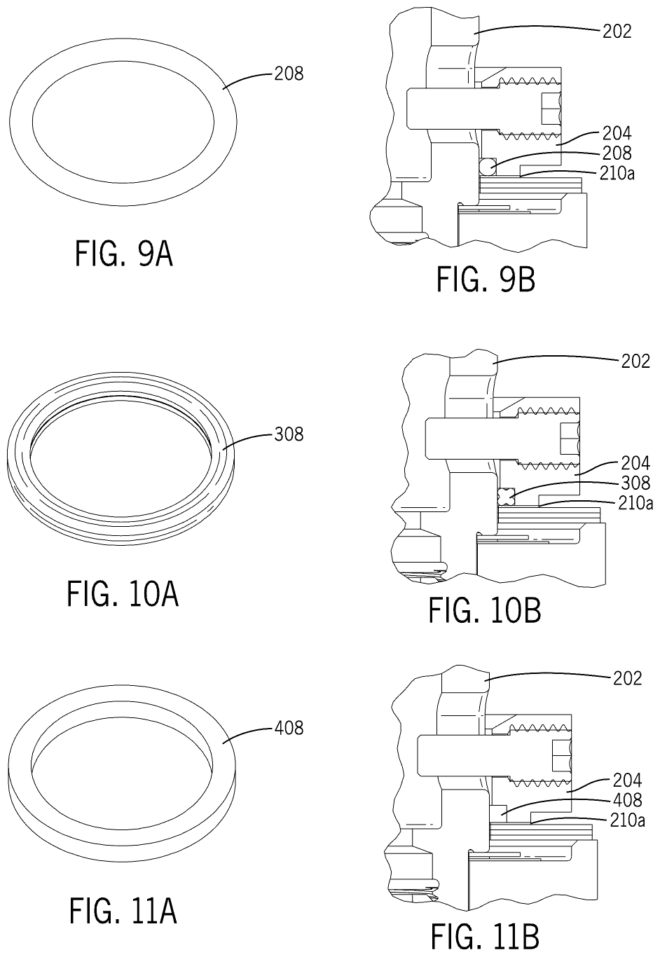

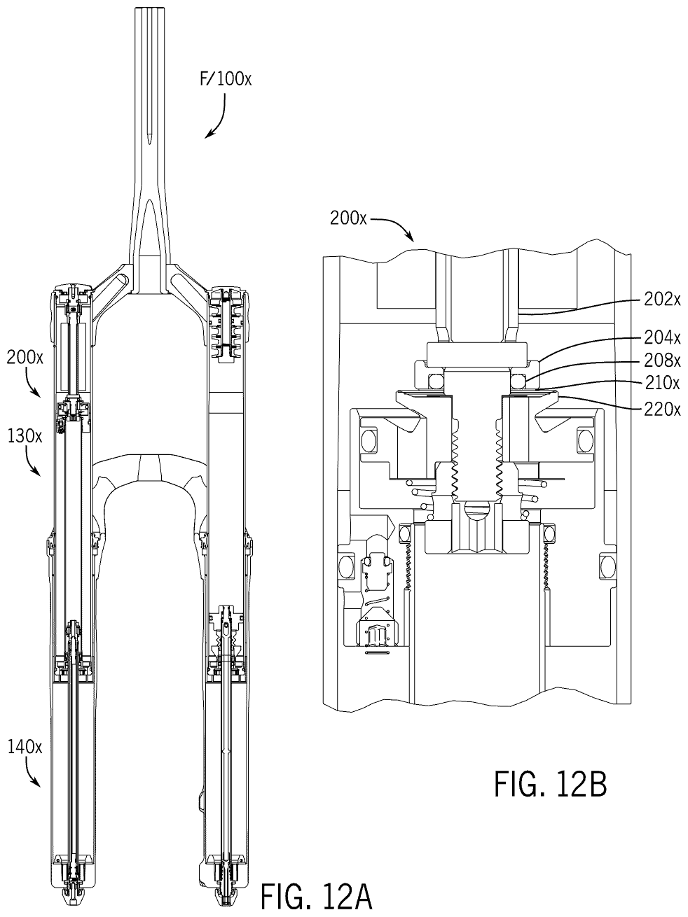

According to an exemplary embodiment as shown schematically in FIGS. 2, 4, 5, 6A-6B, 7 and 8A-8B, the suspension system/assembly may comprise a damper assembly 200 for a shock absorber/suspension system SH/100. According to an exemplary embodiment as shown schematically in FIGS. 3 and 12A-12B, the suspension system/assembly may comprise a damper assembly 200x for a front fork suspension/suspension system F/100x. As shown schematically in FIGS. 4, 5, 6A-6B, 7, 8A-8B and 12A-12B, the damper assembly 200/200x may comprise a shaft shown as main shaft 202/202x with a piston 220/220x and a flow control element/valve shown as shim/shim stack 210/210x for regulating flow of a contained hydraulic fluid; a collar shown as preload collar 204/204x is provided to establish a preload for shim/shim stack 210/210x to establish the fluid pressure below which the valve/shim stack 210/210x will block flow of contained hydraulic fluid (see FIG. 8A) and above which the valve/shim stack 210/210x will allow flow of contained hydraulic fluid (see FIG. 8B); a seal shown as seal ring 208/208x is provided at shim/shim stack 210/210x and at collar 204/204x to substantially prevent/reduce flow of contained hydraulic fluid along an outer surface 202a of shaft 202/202x. See also FIGS. 9A-9B, 10A-10B and 11A-11B.

According to an exemplary embodiment as shown schematically in FIGS. 2, 4, 5, 6A-6B, 7 and 8A-8B, the suspension system 100 comprising a damper assembly 200 may comprise the shaft 202 with outer surface 202a and a piston 220 comprising an internal passage for damping fluid and a flow control element/valve comprising a shim/shim stack 210 (shown as comprising shims 210a/210b) adjacent to the piston 220 configured to fit onto the shaft 202 and a collar 204 configured to apply a preload to the shim/shim stack 210 and a seal shown as a seal ring 208 provided on the shaft 202 at the shim/shim stack 210; the collar 204 may comprise a gland 204a for the seal ring 208 (see FIG. 7); the seal may comprise the seal ring in a sealing engagement with the shim/shim stack and the outer surface of the shaft such that the damping fluid cannot flow between the inner hole of the shim/shim stack and the outer surface of the shaft. See also FIGS. 3 and 12A-12B.

According to an exemplary embodiment as shown schematically in FIGS. 3 and 12A-12B, the suspension system 100x comprising a damper assembly 200x may comprise the shaft 202x with outer surface and a piston 220x comprising an internal passage for damping fluid and a flow control element/valve comprising a shim/shim stack 210x (shown as comprising multiple shims) adjacent to the piston 220x configured to fit onto the shaft 202x and a collar 204x configured to apply a preload to the shim/shim stack 210x and a seal shown as a seal ring 208x provided on the shaft 202x at the shim/shim stack 210x; the collar 204 may comprise a gland for the seal ring 208x (see FIG. 7); the seal may comprise the seal ring in a sealing engagement with the shim/shim stack and the outer surface of the shaft such that the damping fluid cannot flow between the inner hole of the shim/shim stack and the outer surface of the shaft. See also FIGS. 2, 4, 5, 6A-6B, 7 and 8A-8B.

According to an exemplary embodiment as shown schematically in FIGS. 1, 2, 3, 4, 5, 6A-6B, 8A-8B, 9A-9B,10A-10B, 11A-11B and 12A-12B, the damper assembly may be configured for a suspension assembly for a bicycle. As shown schematically in FIGS. 1, 3 and 12A-12B, the suspension assembly may comprise a suspension fork F/100x; the damper assembly 200x may be configured to be contained within the suspension fork F/100x; the suspension fork F/100 may be attached to a bicycle B. As shown schematically in FIGS. 1, 2 and 6A-6B, the suspension assembly may comprise a shock absorber SH/100; the damper assembly 200 may be configured to be contained within the shock absorber SH/100. the damper assembly 200 may be configured to be contained within the shock absorber SH/100; the shock absorber SH/100 may be attached to a bicycle B.

According to an exemplary embodiment as shown schematically in FIGS. 2, 4 and 5, the suspension system/assembly with damper assembly 200 comprises a tube/assembly 130 and a tube/assembly 140 with a cap/top cap 110 with an adjuster 180 and a nut 150 and spacer 152 and a bumper 160 on main shaft 202 and an adjuster needle 156 within a preload shaft 158 and an adjuster cap 154 on the preload shaft 158 and a piston shown as air piston 120; damper assembly 200 comprises main shaft 202 with piston 220 and with flow control element shown as shim stack 222 (with shims 222a, 222b, 222c and 222d) and bolt 230 with washer 234 and check spring 236 and retaining ring 238; main shaft 202 is provided with a flow control element shown as shim stack 212 (with shims 212a, 212b 212c; main shaft 202 is provided with a collar 204 with set screws 206 and a seal shown as a seal ring 208 provided on the shaft 202 at the flow control element shown as shim/shim stack 210 (with shims 210a and 210b). See also FIGS. 1, 2, 3, 6A-6B, 8A-8B, 9A-9B, 10A-10B, 11A-11B and 12A-12B. According to an exemplary embodiment as shown schematically in FIGS. 2, 3, 9A-9B, 10A-10B, 11A-11B and 12A-12B, the seal/seal ring 208/208x at the shim stack 210/210x of the suspension system/assembly for the damper assembly 200 may comprise any of a variety of types of seal/seal ring configurations including a generally conventional elastomer material including a conventional-type O-ring with a generally circular cross-section 208/208x (FIGS. 9A-9B) and/or an X-ring (FIGS. 10A-10B) or a ring with a square/rectangular cross-section (FIGS. 11A-11B).

According to an exemplary embodiment as shown schematically in FIGS. 2, 3, 4, 5, 6A-6B, 8A-8B, 9A-9B, 10A-10B, 11A-11B and 12A-12B, the damper assembly may comprise a damper; the damper may comprise the piston and the shim and the shaft and the collar and the seal ring; the damper may comprise the piston and the shim and the shaft and the collar and the seal ring. The shim may comprise a flow control element; the shim may comprise a valve. The shim may comprise an inner hole; wherein the inner hole may comprise a circular hole. The shaft may comprise an outer surface; wherein the outer surface of the shaft may comprise a cylindrical surface. The collar may be movable along the shaft. The shim may be movable along the shaft. The shim may be configured to close off the internal passage of the piston when the damping fluid pressure may be below a threshold pressure and the shim deflects to open the internal passage of the piston when the damping fluid pressure may be above the threshold pressure. The collar may comprise a gland for the seal. The seal ring may comprise an O-ring; the seal may comprise an X-ring. The preload on the shim may be adjustable. The radially-outer portion of the shim may be configured to contact the piston. The radially-inner portion of the shim may be configured to contact the collar. Position of the collar along the shaft may be configured to change the preload of the shim; position of the collar along the shaft may be user adjustable. The damper assembly may comprise a shaft having an outer surface and a piston comprising an internal passage for damping fluid and a shim adjacent to the piston and with an inner hole configured to fit onto the shaft and a collar configured to apply a preload to the shim and a seal provided on the shaft at the shim; the damper assembly may comprise the collar configured to apply a preload to the shim and the seal provided on the shaft adjacent to the shim.

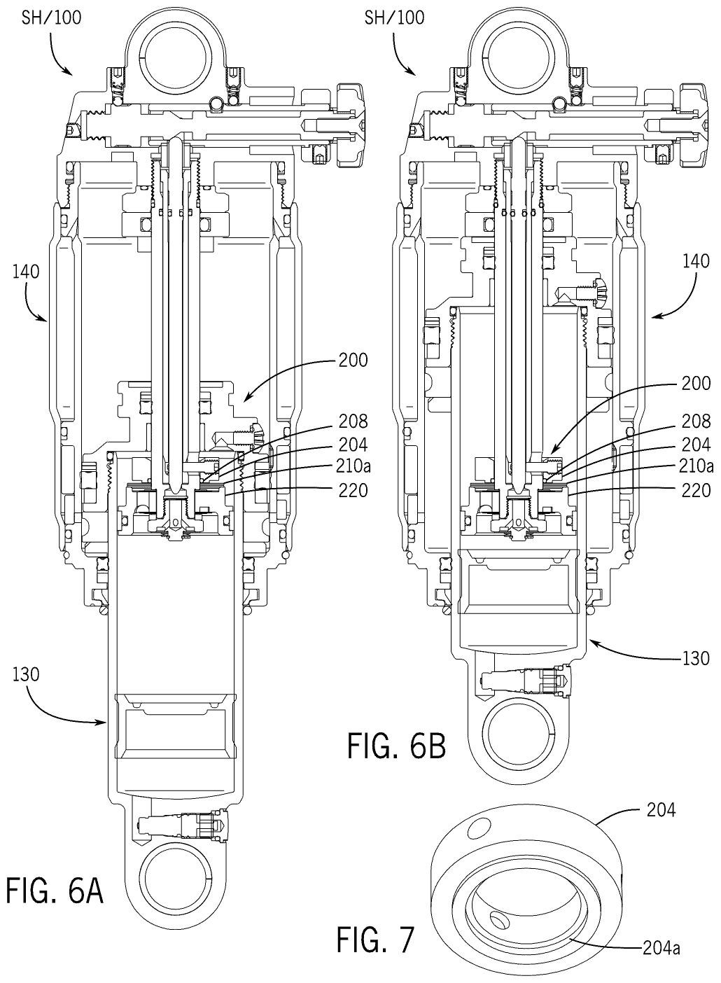

According to an exemplary embodiment as shown schematically in FIGS. 2 and 3, the system may comprise an operator control 180/180x for adjustment of the damper assembly 200/200x; the operator control may comprise an adjuster for the damper assembly; the adjuster for the damper assembly may comprise a knob 180; the adjuster for the damper assembly may comprise a dial 180x; the adjuster may be configured to provide adjustment of position of the collar along the shaft. See also FIGS. 6A-6B, 8A-8B, and 12A-12B.

### Exemplary Embodiments—A

According to an exemplary embodiment as shown schematically in FIGS. 2, 3, 4, 5, 6A-6B and 12A-12B, a suspension system may be configured with a suspension assembly for a bicycle; the suspension assembly may comprise a suspension fork. The damper assembly may be configured to be contained within the suspension fork; the suspension fork may be attached to a bicycle. The suspension assembly may comprise a shock absorber. The system may be configured to be contained within the shock absorber. The shock absorber may be attached to a bicycle.

According to an exemplary embodiment as shown schematically in FIGS. 2, 3, 4, 5, 6A-6B, 8A-8B, 9A-9B, 10A-10B, 11A-111B and 12A-12B, a damper assembly for a suspension system with a chamber for damping fluid may comprise a shaft having an outer surface and a piston comprising an internal passage for damping fluid and a flow control element adjacent to the piston and with an inner hole configured to fit onto the shaft and a seal provided on the shaft adjacent to the flow control element; the seal may be configured to prevent flow of damping fluid along the shaft at the flow control element.

According to an exemplary embodiment as shown schematically in FIGS. 2, 3, 4, 5, 6A-6B, 8A-8B, 9A-9B, 10A-10B, 11A-111B and 12A-12B, a damper assembly may comprise a shaft having an outer surface and a piston comprising an internal passage for damping fluid and a shim adjacent to the piston and with an inner hole configured to fit onto the shaft and a collar configured to apply a preload to the shim and a seal provided on the shaft adjacent to the shim; the system may comprise the seal in a sealing engagement with the shim and the shaft such that the damping fluid cannot flow between the inner hole of the shim and the outer surface of the shaft.

According to an exemplary embodiment as shown schematically in FIGS. 2, 3, 4, 5, 6A-6B, 7, 8A-8B, 9A-9B, 10A-10B, 11A-11B and 12A-12B, a damper assembly may comprise a shaft having an outer surface and a piston comprising an internal passage for damping fluid and a shim adjacent to the piston and with an inner hole configured to fit onto the shaft and a collar configured to apply a preload to the shim and a seal provided on the shaft at the shim; the system may comprise the seal in a sealing engagement with the shim and the shaft such that the damping fluid cannot flow between the inner hole of the shim and the outer surface of the shaft.

As shown schematically in FIGS. 2, 3, 4, 5, 6A-6B, 7, 8A-8B, 9A-9B, 10A-10B, 11A-11B and 12A-12B, the damper assembly may comprise a damper. The damper may comprise the piston and the shim and the shaft and the collar and the seal. The damper may comprise the piston and the shim and the shaft and the collar and the seal. The inner hole of the shim may comprise a circular hole.

As shown schematically in FIGS. 4, 5, 6A-6B, 7, 8A-8B, 9A-9B, 10A-10B, 11A-11B and 12A-12B, the outer surface of the shaft may comprise a cylindrical surface. The collar may be movable along the shaft. The shim may be movable along the shaft. The shim may be configured to close off the internal passage of the piston when the damping fluid pressure may be below a threshold pressure and the shim may be configured to deflect to open the internal passage of the piston when the damping fluid pressure may be above the threshold pressure. The collar may comprise a gland for the seal.

As shown schematically in FIGS. 4, 5, 6A-6B, 7, 8A-8B, 9A-9B, 10A-10B, 11A-11B and 12A-12B, the seal may comprise a ring. The seal may be an O-ring. The seal may comprise an X-ring. The seal may comprise an elastomeric element. The seal may comprise an elastomeric element fit onto the shaft. The flow control element may comprise a shim. The shim may comprise an inner hole. The shim may comprise a circular hole. The outer surface of the shaft may comprise a cylindrical surface. The assembly may comprise a collar configured to apply a preload to the shim.

According to an exemplary embodiment as shown schematically in FIGS. 2, 3, 4, 5, 6A-6B, 7, 8A-8B, 9A-9B, 10A-10B, 11A-11B and 12A-12B, a damper assembly may comprise a piston and a shim and a shaft and a collar and a seal and damping fluid; the piston may comprise an internal passage for the damping fluid; the shim may be adjacent to the piston; the shim may have a preload applied by the collar; the shim may comprise an inner hole; the shaft may comprise an outer cylindrical surface; the outer cylindrical surface of the shaft may be within the shim inner hole; the system may comprise the seal in a sealing engagement with the shim and the shaft such that the damping fluid cannot flow between the shim inner hole and the shaft outer cylindrical surface.

As shown schematically in FIGS. 2, 3, 4, 5, 6A-6B, 7, 8A-8B, 9A-9B, 10A-10B, 11A-11B and 12A-12B, the assembly may comprise a damper. The damper may comprise the piston and the shim and the shaft and the collar and the seal. The collar may be movable along the shaft. The shim may be movable along the shaft. The shim may be configured to close off the internal passage of the piston when the damping fluid pressure may be below a threshold pressure and the shim may be configured to deflect to open the internal passage of the piston when the damping fluid pressure may be above the threshold pressure. The collar may comprise a gland for the seal. The seal may be an O-ring. The seal may be an X-ring.

As shown schematically in FIGS. 4, 5, 6A-6B, 7, 8A-8B, 9A-9B, 10A-10B, 11A-11B and 12A-12B, the preload on the shim may be adjustable; the radially-outer portion of the shim contacts the piston; the radially-inner portion of the shim contacts the collar. The position of the collar along the shaft changes the preload of the shim. The position of the collar along the shaft may be user-adjustable. The adjuster for adjustment of the position of the collar along the shaft may be a knob.

A s shown schematically in FIGS. 4, 5, 6A-6B, 8A-8B, 9A-9B, 10A-10B, 11A-11B and 12A-12B, the seal may be configured to engage with the shim and the shaft to prevent flow of damping fluid between the inner hole of the shim and the outer surface of the shaft. The preload on the shim may be user-adjustable; the position of the collar along the shaft may be user-adjustable.

As shown schematically in FIGS. 2, 3, 4, 5, 6A-6B, 8A-8B and 12A-12B, the operator control shown as an adjuster for adjustment of the position of the collar along the shaft may be a knob or a dial.

### Exemplary Embodiments—B

According to an exemplary embodiment as shown schematically in FIGS. 2, 3, 4, 5, 6A-6B and 12A-12B, a suspension system may be configured with a suspension assembly for a bicycle; the suspension assembly may comprise a suspension fork. The damper assembly may be configured to be contained within the suspension fork; the suspension fork may be attached to a bicycle. The suspension assembly may comprise a shock absorber. The system may be configured to be contained within the shock absorber. The shock absorber may be attached to a bicycle.

According to an exemplary embodiment as shown schematically in FIGS. 4, 5, 6A-6B, 7, 8A-8B, 9A-9B, 10A-101B, 11A-11B and 12A-12B, a damper assembly for a suspension system with a chamber for damping fluid may comprise a shaft having an outer surface and a piston comprising an internal passage for damping fluid and a flow control element adjacent to the piston and with an inner hole configured to fit onto the shaft and a seal provided on the shaft at the flow control element; the seal may be configured to prevent flow of damping fluid along the shaft at the flow control element. The seal may comprise a ring. The seal may comprise an O-ring. The seal may comprise an elastomeric element. The seal may comprise an elastomeric element fit onto the shaft. The flow control element may comprise a shim. The shim may comprise an inner hole. The shim may comprise a circular hole. The outer surface of the shaft may comprise a cylindrical surface. The assembly may comprise a collar configured to apply a preload to the shim. The seal may be configured to engage with the shim and the shaft to prevent flow of damping fluid between the inner hole of the shim and the outer surface of the shaft.

According to an exemplary embodiment as shown schematically in FIGS. 2, 3, 4, 5, 6A-6B, 7, 8A-8B, 9A-9B, 10A-10B, 11A-111B and 12A-12B, a damper assembly for a suspension system with a chamber for damping fluid may comprise a shaft having an outer surface and a piston comprising an internal passage for damping fluid and a shim adjacent to the piston and with an inner hole configured to fit onto the shaft and a collar configured to apply a preload to the shim and a seal provided on the shaft adjacent to the shim; the seal may be configured to engage with the shim and the shaft to prevent flow of damping fluid between the inner hole of the shim and the outer surface of the shaft.

According to an exemplary embodiment as shown schematically in FIGS. 2, 3, 4, 5, 6A-6B, 7, 8A-8B, 9A-9B, 10A-10B, 11A-111B and 12A-12B, a damper assembly for a suspension system with a chamber for damping fluid may comprise a shaft having an outer surface and a piston comprising an internal passage for damping fluid and a shim adjacent to the piston and with an inner hole configured to fit onto the shaft and a collar configured to apply a preload to the shim and a seal provided on the shaft at the shim; the seal may be configured to engage with the shim and the shaft to prevent flow of damping fluid between the inner hole of the shim and the outer surface of the shaft. The inner hole of the shim may comprise a circular hole. The outer surface of the shaft may comprise a cylindrical surface.

According to an exemplary embodiment as shown schematically in FIGS. 2, 3, 4, 5, 6A-6B, 7, 8A-8B, 9A-9B, 10A-10B, 11A-111B and 12A-12B, a damper assembly may comprise a piston and a shim and a shaft and a collar and a seal and damping fluid; the piston may comprise an internal passage for the damping fluid; the shim may be adjacent to the piston; the shim may have a preload applied by the collar; the shim may comprise an inner hole; the shaft may comprise an outer cylindrical surface; the outer cylindrical surface of the shaft may be within the shim inner hole; the system may comprise the seal in a sealing engagement with the shim and the shaft such that the damping fluid cannot flow between the shim inner hole and the shaft outer cylindrical surface. The assembly may comprise a damper. The damper may comprise the piston and the shim and the shaft and the collar and the seal. The collar may be movable along the shaft. The shim may be movable along the shaft. The shim may be configured to close off the internal passage of the piston when the damping fluid pressure may be below a threshold pressure and the shim may be configured to deflect to open the internal passage of the piston when the damping fluid pressure may be above the threshold pressure. The collar may comprise a gland for the seal. The seal may be an O-ring. The seal may be an X-ring. The preload on the shim may be adjustable. The radially-outer portion of the shim contacts the piston. The radially-inner portion of the shim contacts the collar. The position of the collar along the shaft changes the preload of the shim. The position of the collar along the shaft may be user-adjustable. The adjuster for adjustment of the position of the collar along the shaft may be a knob.

According to an exemplary embodiment as shown schematically in FIGS. 1, 2, 3, 4, 5, 6A-6B and 12A-12B, the suspension system may be configured for a suspension assembly for a bicycle. The suspension assembly may comprise a suspension fork. The suspension system may be configured to be contained within the suspension fork. The suspension fork may be attached to a bicycle. The suspension assembly may comprise a shock absorber. The suspension system may be configured to be contained within the shock absorber. The shock absorber may be attached to a bicycle.

### Exemplary Embodiments—C

According to an exemplary embodiment as shown schematically in the FIGS., a suspension system comprising a suspension assembly with a damper assembly may comprise a shaft and a piston comprising an internal passage for damping fluid and a flow control element comprising a shim/shim stack adjacent to the piston configured to fit onto the shaft and a collar configured to apply a preload to the shim and a seal provided on the shaft at the shim; the seal may comprise a seal ring in a sealing engagement with the shim and the shaft such that the damping fluid cannot flow between the inner hole of the shim and the outer surface of the shaft. The damper assembly may comprise a damper; the damper may comprise the piston and the shim and the shaft and the collar and the seal ring; the damper may comprise the piston and the shim and the shaft and the collar and the seal ring. The shim may comprise a flow control element; the shim may comprise a valve. The damper assembly may comprise a shaft having an outer surface and a piston comprising an internal passage for damping fluid and a shim adjacent to the piston and with an inner hole configured to fit onto the shaft and a collar configured to apply a preload to the shim and a seal provided on the shaft at the shim; the damper assembly may comprise the collar configured to apply a preload to the shim and the seal provided on the shaft adjacent to the shim. The damper assembly may comprise the seal in a sealing engagement with the shim and the shaft such that the damping fluid cannot flow between the inner hole of the shim and the outer surface of the shaft. The damper assembly may be configured for a suspension assembly for a bicycle. The suspension assembly may comprise a suspension fork; the damper assembly may be configured to be contained within the suspension fork; the suspension fork may be attached to a bicycle. The suspension assembly may comprise a shock absorber; the damper assembly may be configured to be contained within the shock absorber. The system may be configured to be contained within the shock absorber; the shock absorber may be attached to a bicycle.

According to an exemplary embodiment as shown schematically in the FIGS., a suspension system/assembly comprising a damper assembly may comprise a shaft and a piston and a shim on the shaft and a collar to apply a preload to the shim and a seal in sealing engagement such that the damping fluid cannot flow between shim and outer surface of shaft. The damper assembly may be provided for a suspension fork or shock absorber. The collar and shim are movable along the shaft. The seal may comprise an elastomeric element. Position of the collar along the shaft changes preload of the shim. The shim may be configured to obstruct the internal passage of the piston when the damping fluid pressure is below a threshold and to deflect to open the internal passage of the piston when the damping fluid pressure is above the threshold. A n adjuster may provide adjustment of position of the collar along the shaft. It would be advantageous to provide an improved suspension assembly comprising an improved arrangement for a seal at a flow control element comprising a shim stack/shim. The suspension assembly/system may comprise an arrangement for a seal at a flow control element comprising a shim stack/shim for a damper assembly for a suspension system for a bicycle. The suspension assembly/system may comprise an arrangement for a seal at a flow control element comprising a shim stack/shim for a damper assembly for a suspension system comprising a rear shock absorber. The suspension assembly/system may comprise an arrangement for a seal at a flow control element comprising a shim stack/shim for a damper assembly for a suspension system for a suspension fork. The suspension assembly/system may comprise an arrangement for a seal ring at a flow control element comprising a shim stack/shim for a damper assembly for a suspension system for a bicycle.

According to an exemplary embodiment as shown schematically in the FIGS., a suspension system/assembly comprising a damper assembly may comprise a shaft having an outer surface and a piston comprising an internal passage for damping fluid and a shim stack adjacent to the piston and with an inner hole configured to fit onto the shaft and a collar configured to apply a preload to the shim stack and a seal provided on the shaft adjacent to the shim stack; the seal may be configured to engage with the shim stack and the shaft to prevent flow of damping fluid between the inner hole of the shim stack and the outer surface of the shaft.

### Conventional System

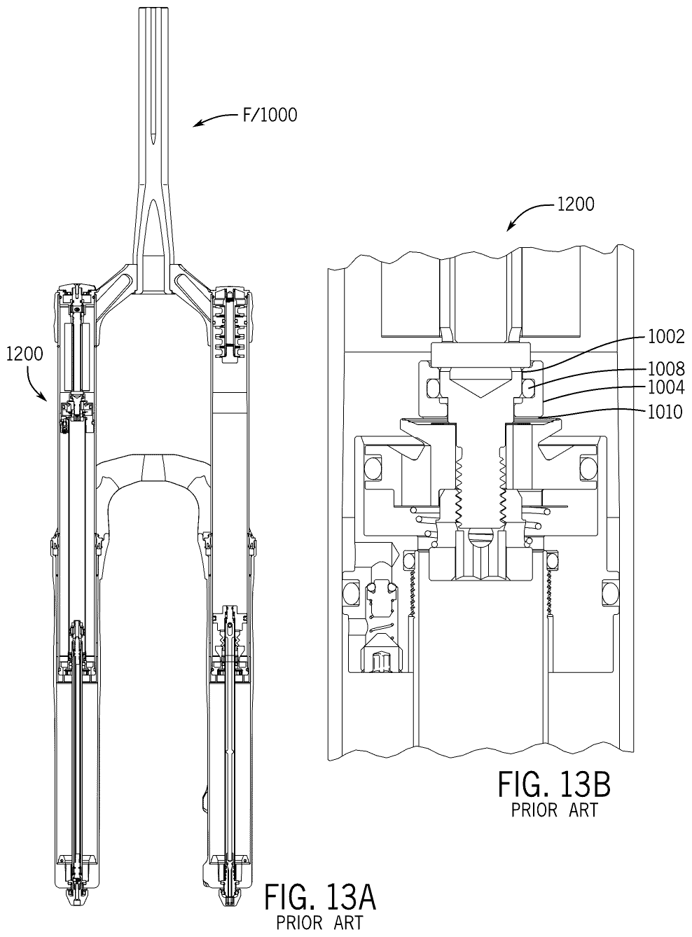

As shown representationally/schematically in FIGS. 13A-13B, a suspension system F/1000 may comprise a suspension fork with a damper assembly 1200 comprising a shaft 1002 and a preload collar 1004 with a seal/ring 1008 separate from the flow control element/shim stack 1010 (seal/ring 1008 within body of collar 1004). See also TA B L E C.

TABLE A

| REFERENCE | |
|---|---|
| SYMBOL | ELEMENT, PART, OR COMPONENT |
| B | BICYCLE |
| FR | FRAME |
| FW | FRONT WHEEL |
| RW | REAR WHEEL |
| SP | SEAT POST |
| S | SEAT |
| T | STEERING TUBE |
| ST | STEM |
| H | HANDLEBAR |
| G | GRIP (HANDLEBAR) |
| F | FRONT FORK ASSEMBLY |
| SH | REAR SHOCK ABSORBER FOR |
| | SUSPENSION SYSTEM |
| BR | BRAKE SYSTEM |
| D | DISC/ROTOR (BRAKE) |
| P | PEDAL |
| TL | TOOL |
| RH | REAR HUB |
| RL | REMOTE LEVER |
| DL | DAMPER LEG |
| SL | SPRING LEG |

TABLE B

| REFERENCE | |
|---|---|
| SYMBOL | ELEMENT, PART, OR COMPONENT |
| 100/100x | SUSPENSION ASSEMBLY |
| 102 | BODY/CAN |
| 108a/108b | MOUNT BUSHING |
| 110 | CAP/TOP CAP (DAMPER ASSEMBLY) |
| 120 | PISTON ASSEMBLY (PISTON/AIR PISTON) |
| 130/130x | TUBE/ASSEMBLY (DAMPER TUBE ASSEMBLY) |
| 140 | TUBE/ASSEMBLY (AIR CAN ASSEMBLY) |
| 140x | TUBE/ASSEMBLY (LOWER CASTING) |
| 150 | NUT |
| 152 | SPACER |
| 154 | ADJUSTER CAP |
| 156 | ADJUSTER NEEDLE |
| 158 | PRELOAD SHAFT |
| 160 | BUMPER |
| 162 | SEAL (RING/O-RING) |
| 180/180x | OPERATOR CONTROL (ADJUSTER KNOB/DIAL) |
| 200/200x | DAMPER ASSEMBLY |
| 202/202x | MAIN SHAFT |
| 202a | OUTER SURFACE (MAIN SHAFT) |
| 204/204x | COLLAR (PRELOAD COLLAR) |
| 204a | SEAL GLAND (PRELOAD COLLAR) |
| 206 | SET SCREW |
| 208/208x | SEAL (RING/SEAL RING) |
| 308 | |
| 408 | |
| 210/210x | FLOW CONTROL ELEMENT (VALVE/SHIM |
| | STACK) |
| 210a, 210b | SHIM (SHIM STACK) |
| 212 | FLOW CONTROL ELEMENT (VALVE/SHIM |
| | STACK) |
| 212a, 212b, | SHIM (SHIM STACK) |
| 212c | |
| 220/220x | PISTON |
| 222 | SHIM STACK |
| 222a, 222b, | SHIM (SHIM STACK) |
| 222c, 222d | |
| 230 | BOLT |
| 232 | SHIM |
| 234 | WASHER |
| 236 | SPRING (CHECK SPRING) |
| 238 | RING (RETAINING RING) |

TABLE C

| REFERENCE | |
|---|---|
| SYMBOL | ELEMENT, PART, OR COMPONENT |
| 1000 | SUSPENSION ASSEMBLY |
| 1002 | SHAFT |
| 1004 | PRELOAD COLLAR |
| 1008 | SEAL (RING) |
| 1010 | FLOW CONTROL ELEMENT/SHIM STACK |
| 1200 | DAMPER ASSEMBLY |

It is important to note that the present inventions (e.g. inventive concepts, etc.) have been described in the specification and/or illustrated in the FIGS. of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGS. is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGS. of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A suspension system comprising a damper assembly comprising:
(a) a shaft;
(b) a piston comprising an internal passage for damping fluid;
(c) a shim adjacent to the piston configured to fit onto the shaft;
(d) a collar configured to apply a preload to the shim;
(e) a seal provided on the shaft at the shim;
wherein the seal is in sealing engagement with the shim and the shaft such that the damping fluid cannot flow between the shim and an outer surface of the shaft.

2. The system of claim 1 comprising a suspension fork; wherein the damper assembly is configured to be contained within the suspension fork.

3. The system of claim 1 comprising a shock absorber; wherein the damper assembly is configured to be contained within the shock absorber.

4. The system of claim 1 wherein the collar is movable along the outer surface of the shaft; wherein the shim is movable along the outer surface of the shaft.

5. The system of claim 1 wherein the shim is configured to close off the internal passage of the piston.

6. The system of claim 1 wherein a radially-outer portion of the shim contacts the piston; wherein a radially-inner portion of the shim contacts the collar.

7. The system of claim 1 wherein the seal comprises an elastomeric element.

8. The system of claim 1 wherein the seal comprises an O-ring.

9. The system of claim 1 wherein the collar comprises a gland for the seal.

10. The system of claim 1 wherein position of the collar along the shaft changes the preload of the shim.

11. The system of claim 1 wherein the preload on the shim is adjustable by an adjuster.

12. The system of claim 11 wherein position of the collar along the shaft is user adjustable by the adjuster.

13. The system of claim 1 wherein the shim is configured to obstruct the internal passage of the piston when the damping fluid pressure is below a threshold pressure and the shim is configured to deflect to open the internal passage of the piston when the damping fluid pressure is above the threshold pressure.

14. The system of claim 1 wherein the shim comprises a flow control element; wherein the operator control is configured to provide adjustment of position of the collar along the shaft for the flow control element.

15. A damper assembly for a suspension system comprising:
(a) a shaft having an outer surface;
(b) a piston comprising an internal passage for damping fluid;
(c) a flow control element adjacent to the piston and configured to fit on the shaft;
(d) a seal provided on the shaft adjacent to the flow control element;
wherein the seal is configured to prevent flow of damping fluid along the shaft at the flow control element.

16. The assembly of claim 15 wherein the seal comprises an elastomeric ring fit onto the shaft.

17. The assembly of claim 15 wherein the flow control element comprises a valve; wherein the seal is configured to engage the valve and the shaft to prevent flow of damping fluid between the valve and the outer surface of the shaft.

18. The assembly of claim 15 wherein the flow control element comprises a shim; wherein the seal is configured to engage the shim and the shaft to prevent flow of damping fluid between the shim and the outer surface of the shaft.

19. The assembly of claim 18 further comprising a collar configured to apply a preload to the shim; further comprising an operator control for adjustment of the damper assembly; wherein the operator control is configured to provide adjustment of position of the collar along the shaft.

20. A suspension assembly comprising a damper assembly comprising:
(a) a shaft;
(b) a piston;
(c) a shim;
(d) a collar;
(e) a seal;
(f) an operator control;
wherein the piston comprises an internal passage for damping fluid;
wherein the shim is fit on the shaft and adjacent to the piston;
wherein the shim has a preload applied by the collar;
wherein the operator control is configured to provide adjustment of the preload by movement of the collar along the shaft;
wherein the seal is in sealing engagement with the shim and the shaft such that damping fluid cannot flow between the shim and the shaft.
